(19) United States
(12) Patent Application Publication
(10) Pub. No.: US 2013/0047458 A1
(43) Pub. Date: Feb. 28, 2013

(54) BIOMASS DRYING SYSTEM

(71) Applicants: Bridget Bero, Flagstaff, AZ (US); Alarick Reiboldt, Flagstaff, AZ (US)

(72) Inventors: Bridget Bero, Flagstaff, AZ (US); Ward Davis, Flagstaff, AZ (US); Alarick Reiboldt, Flagstaff, AZ (US)

(73) Assignee: Northern Arizona University, Flagstaff, AZ (US)

(21) Appl. No.: 13/353,214

(22) Filed: Jan. 18, 2012

Related U.S. Application Data
(60) Provisional application No. 61/527,021, filed on Aug. 24, 2011.

(51) Int. Cl. F26B 3/08; F26B 25/06; F26B 17/12; F26B 3/10; F26B 17/10

(52) U.S. Cl. 34/370; 34/375; 34/487; 34/491; 34/589; 34/168; 34/209

(57) ABSTRACT

The present invention relates to a biomass product drying system having a fluidized bed for mixing, drying and transporting the biomass product through one or more stages in order to sufficiently dry the biomass product for commercial markets.

### CROSS-REFERENCE TO RELATED APPLICATIONS

This application is a U.S. Non-provisional application filed claiming priority to U.S. Provisional Application Ser. No. 61/527,021 filed Aug. 25, 2011 and entitled “LOW-TEMPERATURE WOODY BIOMASS DRYING SYSTEM,” which is incorporated herein by reference in its entirety.

### FIELD OF INVENTION

The present invention relates to a system and method for drying a biomass material more efficiently.

### BACKGROUND OF THE INVENTION

Harvesting forest products produces a substantial amount of biomass material in the form of slash. This biomass material is used as a fuel for numerous systems. However, prior to using the biomass waste as fuel it is optionally dried to a sufficient degree. Various systems exist for drying the biomass material. One example is a rotary kiln and other similar plug-flow-type) dryer. The rotary kiln dryer uses substantial amounts of energy transferring heat from the kiln walls to the biomass waste, losing beneficial secondary products (e.g. pine oils) as emissions. Another example is the belt dryer which conveys wood chips along a belt using lower temperature but huge volumes of air to remove the moisture. The belt system does not mix the biomass material and also loses secondary products. Yet another example is the fluid bed hog fuel dryer (U.S. Pat. No. 4,628,833). The fluid bed hog fuel dryer also uses high-temperatures and fails to capture the secondary products.

### SUMMARY OF THE INVENTION

As set forth in the detailed description, in accordance with various aspects of the present invention, devices and systems for drying a biomass product are disclosed. Accordingly in various embodiments, methods for drying a biomass product may include introducing the biomass product into a chamber in a vessel and injecting a fluidizing media into the chamber fluidizing the biomass product in the chamber's bed. Prior to entering the chamber, the biomass product may have a first moisture content. After a sufficient residence time in the chamber, the biomass product may have a second moisture content. The length of the residence time may depend on the desired moisture content of the final dried biomass product.

In another exemplary embodiment, a drying system may have at least one chamber. The chamber may include a bed for drying a biomass product. The chamber may include an inlet for receiving a biomass product. The chamber may include a downcomer in communication with the inlet. The downcomer may direct the biomass product to a low point in the chamber. At the low point a fluidizing media may transport the biomass product up into the chamber. The chamber may further include a riser configured to direct the biomass product being transported by the fluidizing media. The riser may have an inlet at the bottom for the fluidizing media to enter the riser. The fluidizing media may be delivered as a high velocity stream configured to move the biomass product higher in the riser. The chamber may further include a baffle located between the downcomer and the riser.

In still another exemplary embodiment, a drying system may comprise one or more chambers contained in one or more vessels. The vessel may be any system or mechanism configured to contain, transport, and/or secure the chambers. In one example, the vessel may be a trailer configured to locate the drying system in a forested area. The vessel may he placed in communication with a second vessel such that the two or more vessels may operate as a continuous system. The chambers may be in communication with a second chamber. The two or more chambers may be contained in a single vessel. The drying system may further comprise one or more drying stages. Each chamber may have one or more drying stages. A first drying stage may control a first characteristic (e.g. temperature, fluidizing media speed, residence time, or the like) for example a first temperature in the chamber. A second drying stage may change the characteristic having for example a second temperature in the chamber. The drying system may include any combination of one or more vessels, chambers, and stages. Furthermore the drying system may be a batch system or a continuous system. For example, a single chamber may be a hatch system with only one inlet and automatic exit. in another example, a single chamber may be a continuous system with an inlet that continuously receives biomass product and an outlet than continuously removes biomass product.

In yet another exemplary embodiment, a drying system may include a condenser. In a multistage system the condenser may be configured to capture volatized internal oils and water-soluble aromatic compounds from the biomass product. A first stage, of the multi-stage system, may use air below ambient temperature. A second stage, of the multi-stage system, may use air above ambient temperature.

In still another exemplary embodiment, a drying system may include a chamber and a fluidizing media introduced into the chamber. Mechanisms used to supply the fluidizing media may include at least one of a pneumatic conveyance, bellow, compressor, fast-acting butterfly valve(s), blower, or any other device configured to deliver the fluidizing media to the biomass product. The fluidizing media may come from a variety of sources including atmospheric air, heated air and/or exhaust air. The supply mechanism may provide a pulsed fluidizing media. The pulsed fluidizing media may be delivered to the chamber on a slow cycle or a very fast cycle. The pulsed fluidizing media may cycle slow enough to allow the biomass material to fully settle. Alternatively, the pulsed fluidizing media may cycle sufficiently fast that the air appears to be an uninterrupted stream. The cycle duration may be optimized to provide the best conditions depending on the characteristics of the biomass material.

Further objects and advantages will become apparent as the following description proceeds and the features of novelty which characterize this invention will be pointed out with particularity in the claims annexed to and forming a part of this specification.

### BRIEF DESCRIPTION OF THE DRAWINGS

The subject matter of the invention is particularly pointed out and distinctly claimed in the concluding portion of the specification. The invention, however, both as to structure and method of operation, may best be understood by reference to the following description taken in conjunction with the claims and the accompanying drawing figures, in which like parts may be referred to by like numerals.

FIG. 1 is a schematic of a single chamber biomass dryer system in accordance with an exemplary embodiment of the present invention.

FIG. 2 is a schematic of a multi-chamber biomass dryer system in accordance with an exemplary embodiment of the present invention.

FIG. 3 is a schematic of a multi-chamber biomass dryer system with a recycler in accordance with an exemplary embodiment of the present invention.

FIG. 4 is a schematic of a pulsed batch biomass dryer system in accordance with an exemplary embodiment of the present invention.

FIG. 5 is a flow diagram of a biomass dryer system in accordance with an exemplary embodiment of the present invention.

### DETAILED DESCRIPTION

The detailed description herein makes use of various exemplary embodiments to assist in disclosing the present invention. While these exemplary embodiments are described in sufficient detail to enable those skilled in the art to practice the invention, it should be understood that other embodiments may be realized and that modifications of structures, arrangements, applications, proportions, elements, materials, or components used in the practice of the instant invention, in addition to those not specifically recited, can be varied or otherwise particularly adapted to specific environments, manufacturing specifications, design parameters or other operating requirements without departing from the scope of the present invention and are intended to be included in this disclosure. Thus, the detailed description herein is presented for purposes of illustration only and not of limitation.

In accordance with one aspect, a biomass drying system is provided. The drying system may be configured to dry a biomass product using a fluidized-bed drying system. A biomass product may, as our example, include any granular biomass material that can be dried prior to being transported from the point of harvest. For example a biomass product may include woody biomass waste from a defrosting project. The woody biomass waste may be any of a combination of wood chips, needles, bark, leaves, etc. The waste may also come from a plurality of sources including tree species. A compilation of various woody biomass waste products may be refereed to as slash.

In accordance with various embodiments the fluidized-bed may be established utilizing an air flow system that allows for efficient fluidization of the biomass product. Without limiting the scope of the invention by explanation of theory, it is believed that fluidizing the biomass product allows for high heat and mass transfer, meaning lower required processing time which translates into faster drying. Furthermore, a fluidized bed dryer works especially well with biofuels, especially wood-biomass product, but may be configured to work with any material that requires drying, especially small, irregularly shaped materials.

In accordance with one aspect, the biomass drying system may he configured to minimize energy required for drying by providing precise control over biomass movement through the system by controlling system elements including at least one of baffles, gates, air flow rates, and air temperature. In accordance with further embodiments, environmental conditions may be monitored on the interior and/or exterior of the system. Adjustments of the drying system may be made by monitoring the system and controlling the system elements as part of a feedback system. For example, separate stages in the system may provide different temperatures of fluidizing media ranging from sub-ambient (i.e. cold) to temperatures greater than ambient (i.e. hot). Due to numerous physical variables including for example the rate of water absorption from the biomass product to the air, temperatures at which greater amounts of pollution is emitted, and reaction temperatures of oils in the biomass product, the amount of energy added to the system in the form of air speed and air temperature may he finely controlled.

In accordance with an aspect of the present invention, the biomass drying system may he configured as a small, portable, dryer for chipped woody biomass that may be operated in situ with harvesting operations such as forest thinning. By using air to transport biomass product through the system, moisture out of the system and energy into the system, the biomass drying system may be compact with few moving parts. Unit size may be minimized by high gas to biomass contact, and the energy of the gas may be used as the primary means of material conveyance through the drying stages.

In accordance with an aspect of the present invention, the biomass drying system may be configured to reduce the moisture content of the biomass product down to desirable content to improve transportation efficiencies. In various embodiments the biomass drying system may be used to reduce the moisture content of the biomass product down to a moisture content that may be desirable for specific industrial applications. For example, in various commercial applications it may be desirable to chip and dry a biomass product to 10% moisture. The biomass product may then he processed into pellets and sent directly to commercial markets.

In accordance with an aspect of the present invention, a biomass drying system may he configured to capture internal oils from the biomass material. In one embodiment, the system may capture volatile oils and water-soluble aromatic compounds from woody material as secondary products. For example these oils may include pine oils that are light, fragrant, primarily mono- and sesqui-terpene compounds that may be used as bio-based solvents, fragrances, pharmaceuticals, biocides, adhesives and polymers. Water in the biomass material that may be released during the drying may also contains soluble chemicals such as organic acids, which may have applications as fungicides and biocides. Furthermore, capturing the volatile oils and water-soluble aromatic compounds reduces pollutants released from the drying of biomass material.

In accordance an aspect of the invention, the biomass drying system may comprise at least one chamber having a continuous fluidized bed. The continuous fluidized bed may be established by utilizing an air flow system that moves air through the chamber, continuously fluidizing the biomass product in the bed.

In accordance with one embodiment, the fluidization may comprise cyclic movement of the biomass material to prevent the air from creating holes through the biomass material. Allowing the air to escape through holes or channels the air creates through the biomass material without significantly disrupting the material may be referred to as “rat holing”. For example, the air may be energetically pulsed through the biomass material allowing the material to move, while preventing rat holing. The pulses of air may be delivered to the chamber on a slow cycle or a very fast cycle depending on the conditions of the biomass material including, size, weight, type, and moisture content. In one example, the pulsed air cycle may be slow enough to allow the biomass material to fully settle. In another example, the pulsed air cycle may be sufficiently high that the air appears to be an uninterrupted stream creating a continuous or near continuous fluidized bed. The cycle duration may be optimized to provide the best conditions depending on the characteristics of the biomass material. Mechanisms used to create the pulses include a pneumatic conveyance, bellow, compressor, fast-acting butterfly valve(s), blower, or any other device configured to deliver an energetic pulse of air the wood biomass product. The parameters for the pulses of air fluidize a material to be dried, such as wood biomass product or food particles.

In accordance with one embodiment, the fluidization of a biomass product may comprise a constant stream of air delivered to the chamber. The air may be delivered to a downward sloping channel or bed, also referred to herein as “downcomer.” The downcomer may be at a downward angle of anywhere between 0 and 90 degrees. The angle may be more preferably between 25 and 65 degrees. The angle may also be more preferably about 45 degrees. The air may be delivered to the bed through an upward sloping channel or bed, also referred to herein as an “riser.” The riser angle may be anywhere greater than 0 degrees up to vertical. Preferably the riser may be vertical. The riser may be configured to direct the biomass product upward.

In accordance with various embodiments, the downcomer and the riser may have an opening connecting their respective separate channels. In accordance with another embodiment, the downcomer and the riser may be in a single chamber and distinguished by different air velocities. The different air velocities may be referred to as a “high velocity” and a “low velocity” with the high velocity being greater than the low velocity. In accordance with various embodiments, the downcomer may have a low velocity air supply and/or the riser may have a high velocity air supply. In accordance with another embodiment, the downcomer may have no air supply and/or the riser may have a air supply with sufficient velocity to transport the biomass product up the riser. In accordance with various embodiments the low velocity air supply and/or the high velocity air supply may be a pulsed air supple and/or a constant air supply.

In accordance with various embodiments of the present invention, a drying system may comprise a chamber with a downcomer section and a riser section. In another embodiment, chamber may have a downcomer without a riser section but still have a high velocity air supply below the downcomer to transport the biomass material back to the downcomer. The riser may provide the biomass product a high energy exposure to the fluidizing media. The downcomer may provide the biomass product a low energy longer duration mixing with the fluidizing media. The fluidizing media and/or downcomer may provide the biomass product a transport mechanism to move the biomass product through the drier system. The biomass product may first enter the downcomer section and be motivated through the downcomer section by an upward flowing low-velocity drying gas. This section may be fluidized by low-velocity drying gas introduced into the downcomer by gas nozzles, slots, jets or any known or otherwise developed air port. This low-velocity drying gas may be controlled by either the supply source (e.g. pump, fan, compressor, exhaust, etc) or by the opening into the downcomer (e.g. nozzle, slot, jet, etc). The low-velocity drying gas may provide at least enough fluidization to induce the biomass product to flow freely by gravity. The low-velocity drying gas may have enough velocity to continuously mix the biomass product as it flows through the downcomer. Optionally, the downcomer may operate without a fluidizing media. While passing through each downcomer, the biomass product may be continuously mixed by the jets of drying gas from the slots. This jetting action prevents rat holing, while still providing the mixing action needed for effective use of the drying gas during moisture removal. The drying gas velocity may be limited such that it may be not capable of moving the biomass product up the downcomer or otherwise impeding fluidized flow down the downcomer. In various embodiments, the material in the downcomer may be barely fluidized if at all. It may be preferable that the material stay well mixed so the biomass product is dried evenly. The combination of gravity and air flow through the downcomer keeps the biomass product fairly well mixed.

In still another exemplary embodiment, a drying system may include one or inure chambers contained in one or more vessels. The vessel may be any system or mechanism configured to contain, transport, and/or secure the chambers. In one example, the vessel may be a trailer configured to locate the drying system in a forested area. The vessel may be placed in communication with a second vessel such that the two or more vessels may operate as a continuous system. The vessel may be placed in communication with a second vessel such that the two or more vessels may operate as a continuous system. The chambers may be in communication with a second chamber. The two or more chambers may be contained in a single vessel. The drying system may further comprise one or more drying stages. Each chamber may have one or more drying stages. A first drying stage may control a first characteristic (e.g. temperature, fluidizing media speed, residence time, or the like) for example a first temperature in the chamber. A second drying stage may change the characteristic having for example a second temperature in the chamber. The drying system may include any combination of one or more vessels, chambers, and stages. Furthermore the drying system may be a batch system or a continuous system. For example, a single chamber may be a batch system with only one inlet and not automatic exit. In another example, a single chamber may be a continuous system with an inlet that continuously receives biomass product and an outlet that continuously removes biomass product.

In various embodiments, the biomass product may travel sequentially from bed to bed. As diffusion of water from the biomass product limits the water removal rate in the last dryer beds the downcomer size may be increased, or the dryer gas rate may be decreased, to more effectively use the available drying gas. Recirculation or recycling of the riser biomass product back to the bed allows good mixing and higher residence time in these beds. Excellent mixing of the drying gas and the biomass product allow the necessary heat for drying to he transferred at much lower temperatures. In an exemplary embodiment, mixing allows the outlet air to be nearly saturated with water. This may cool the bed to near the wet-bulb temperature (about 55° F. without heat addition). Drying performance may be predicted from basic heat-and-heat-material-balances by using a time-slice analysis.

At the bottom of the downcomer the biomass product may be agitated and/or accelerated by a high velocity jet of drying gas. The biomass product may then be conveyed rapidly upward in the riser. In on embodiment, there may be no riser but a high velocity jet of drying gas may accelerate the biomass product up into the chamber and/or to the top of the downcomer without the restriction of a riser. In accordance with various embodiments of the present invention, the top of the riser may comprise a deflector. In one embodiment the deflector may be configured to divide the fluidized biomass stream. A controlled fraction of the biomass product striking the deflector may be recycled back to the downcomer bed, while the remaining fraction of the biomass product is conveyed onward to the next bed. In accordance with one embodiment, the deflector may also comprise a gate allowing greater control of the biomass stream by preventing if from recycling or advancing or substantially limiting the amount of the stream that is recycled or advanced. The deflector and/or gate may be incorporated into a drying system with a single chamber or a drying system with multiple chambers. Moreover, the deflector and/or gate may be incorporated into a batch system and/or a continuous system. For example, in a batch the dryer system may maintain the biomass material in a single chamber until the desired moisture content is reach. A system controller may then open the gate to allow the fluidizing media to force the biomass material out of the chamber and into a collection bin. In another example, the gate and/or deflector may direct the biomass material to advance to a second chamber in the same vessel. In another example, the gate and/or deflector may direct the biomass material to another vessel and/or a collection bin to be processed through another vessel.

In accordance with various embodiments, the biomass product may be transported through a system of drying stages separated by the adjustable baffles. In accordance with various embodiments, a first chamber and a second chamber may be separated by a baffle. For example, a downcomer may be separated from a riser by a baffle, in another example, a riser may be separated from a subsequent downcomer by a baffle. In another embodiment a baffle may be used to release biomass product to a storage container or the like. An adjustable baffle may be used in the drying system to optionally compensate for variation in raw material moisture contents by allowing for more resident time in the downcomer. For example, a baffle located where the down corner and the riser connect may be adjustable such that it may allow a variable amount of biomass material into riser. The baffle between the downcomer and the riser may be raised or lowered, creating a gate that allows a controlled amount of material to enter the bottom of the riser. In one embodiment a plurality of communicating chambers with downcomers and risers in each chamber may allow the drying larger undried particles and removing smaller dried particles from the system by controlling the opening on baffles separating the downcomers and risers and each of the chambers.

In accordance with various embodiments, the biomass product may be controlled by the fluidizing media (air) carrying the biomass product through the system in a way such that smaller, more easily dried particles pass through more quickly, and allowing the bulk of the particles to be slowed down by the baffles and to exit the system at the desired moisture content. The velocity may be considerably higher in the riser as the biomass product exits the downcomer and enters the riser near the baffle. A variable opening nozzle at the bottom of the riser may control the amount of air entering the riser. By manipulating the gate and the nozzle very good control over the flow of material may be maintained.

Pneumatic conveyance may also be used to move the biomass product from bed to bed. Multiple beds may be used in order to vary dryer gas rates and temperatures in different parts of the system. The movement of the biomass product from bed to bed is performed by transporting the biomass product upward and onward as the biomass product leave each bed. in this process the biomass product is propelled with more gas and much more violently than during fluidization. It has the advantage of causing very thorough mixing as the biomass product move from bed to bed, and allows the bed depths to be varied from bed to bed. The biomass product move along each individual bed by gravity. Once fluidized the biomass product act like water and flow along a slanted bed.

In one exemplary embodiment, the slant of the downcomers, followed by the riser, results in a saw-tooth shaped layout. In another embodiment, the layout of the dryer system may slope, so the saw-tooth shape is less pronounced. in another embodiment, the dryer system may have a horizontal layout.

In accordance with various embodiments, a micro-computer may be used to control temperature, residence time, velocity, and/or pulse interval for the air introduced into the system. Sensors in the dryer system may provide a feedback mechanism to the micro-computer allowing the computer to control the baffles, gates, and air supply (including velocity and temperature) effectively controlling residence times of the biomass product in the various beds and stages allowing for optimal drying. Such sensors may include, air temperature, biomass material temperature, pressure, relative humidity, dew point, inferred image of biomass, air velocity, mass air flow, biomass material weight, biomass material weight change, and/or any other known or developed sensor. Although conditions may change from the first to the last dryer bed, these same feedback control systems may be employed so the same bed physical design may be set to perform at any location in the dryer. Varying the size and/or geometry of the air ports, the slope and geometry of the beds, and/or other system characteristics may also provide a way to control the efficiency of the system.

In accordance with one aspect of the system, the dryer system may control the residence time in any particular bed to allow the water in the biomass product to diffuse to the surface where it may be swept away by the passing air. This may be especially true at low temperatures. Without limiting the scope of the invention by explanation of theory, it is believed that residence time may not be as important in the first beds where surface water is available and may be easily removed, but once the moisture content is down to about 50% the diffusion from inside the biomass product becomes a controlling factor. In this region it may not he very useful to increase air flow or fluidization because with little water to strip away the air would not become saturated with water, and is effectively wasted. This residence time is obtained by having a fairly high holding volume in the beds near the downcomer outlet, and reducing the air rates.

In accordance with various aspects of the present invention, the drying system may comprise a multi stage system. In accordance with various embodiments, each stage in the drying system may use a different air temperature. In one example, the temperature may increase as stages progress. In another example, the temperatures may decrease as the stages progress.

In accordance with one exemplary embodiment, a first stage may be a cold air stage (i.e. ambient temperature or less). This first stage may reduce moisture content in the biomass product (e.g. surface water). For example the moisture content may decrease from about 50% to about 35% and preferably less than about 25%. Given enough residence time in the system cold air may be able to reduce the content to about 20%. Using cold air to reduce the moisture content may substantially increase the biomass product's resident time in one or more chambers in order to reduce the moisture content down to an optimal range. However, by using cold air to reduce the moisture content, volatilization of the internal oils may be minimized. The low temperature operation reduces the chance of oxidation of volatile compounds and fines which may create “blue haze.” The cold air exhaust may be released directly to the atmosphere and/or pass through a particulate control cyclone prior to being released into the atmosphere. The downside of lower temperatures is the reduced amount of water vapor that may he carried out by the drying air, resulting in higher air requirements (higher operating cost). To use the air efficiently, one may run the outlet air as close to saturated (100% relative humidity) as possible.

In accordance with one exemplary embodiment, a second or subsequent stage may he a hot air stage (i.e. air greater than ambient temperature). This second stage may quickly reduce moisture content in the biomass product without increased resident time in the system. A hot air stage may dry the biomass product to about 20% and preferable to about 10% moisture content. Furthermore, a hot air stage may rapidly volatilize the internal oils allowing them to he released into the atmosphere and/or be captured. In accordance with one embodiment, the volatilized internal oils may be collected in a condenser. The hot air stage internal oil removal/collection efficiency may he increased by reducing the biomass product to a low moisture content relative to internal oil content. The process may further include separating the condensed oils from additional condensed water via gravity separation. The hot air exhaust from the heated stage may be condensed to recover internal oils and/or the heated air may also be released to the atmosphere after passing through a cyclone. In one embodiment, the hot air may be greater than 160° F. at which temperature it is believed that blue haze may form. In one embodiment, the air may be less than 160° F. substantially preventing the blue haze from forming and/or limiting volitization of internal oils. In one embodiment, the hot air may be greater than 450° F. at which temperature some biomass products such as woody material may begin reacting with the air (e.g. oxidizing), in one embodiment, the hot air may be less than 450° F., keeping the biomass products such as woody material from reacting. In another embodiment the hot air may be greater than 200° F. in another embodiment the air may be less than 200° F. For certain commercial applications it may he beneficial to dry the biomass material at temperatures as high as 1000° F. to remove substantially all moisture from the biomass product.

In accordance with various embodiments, the drying system may operate with one or more stages. A first stage may be either a hot air stage or a cold air stage. Similarly, a second or subsequent stages may be either hot air or cold air stages. Furthermore the system may operate with one or more cold air stages. For example, the heated stage may be disengaged if oil capture is not desired and residence time in the system is not an issue. The system may alternatively operate with one or more hot air stages. For example, the system may operate with only hot air stages if residence time in the system is an issue. Single vessels, multiple vessels, single chamber, and multiple chamber systems may each operate with one or more stages, having for example both a hot and cold stage. Furthermore, both batch and continuous systems may operate as either a single stage system or as multi-stage systems, having for example both a hot and cold stage.

The temperatures in the stages may be optimized according to drying needs (e.g. final moisture content, recovery of oils, etc.), available drying timeframes (i.e. the length of time biomass product reside in the system), and/or desired efficiency. For example, separate cold and hot stages maximize energy efficiency. In accordance with various embodiments, the temperature may be controlled in response to feedback received from any of a variety of sensors (e.g. relative humidity, weight, inferred, direct product sampling, etc.) indicating the relative reduction in the moisture of the biomass product. In accordance with one embodiment heat may he added to the drying air by incorporating waste heat from support machinery (generators, blowers, downstream processing equipment, etc).

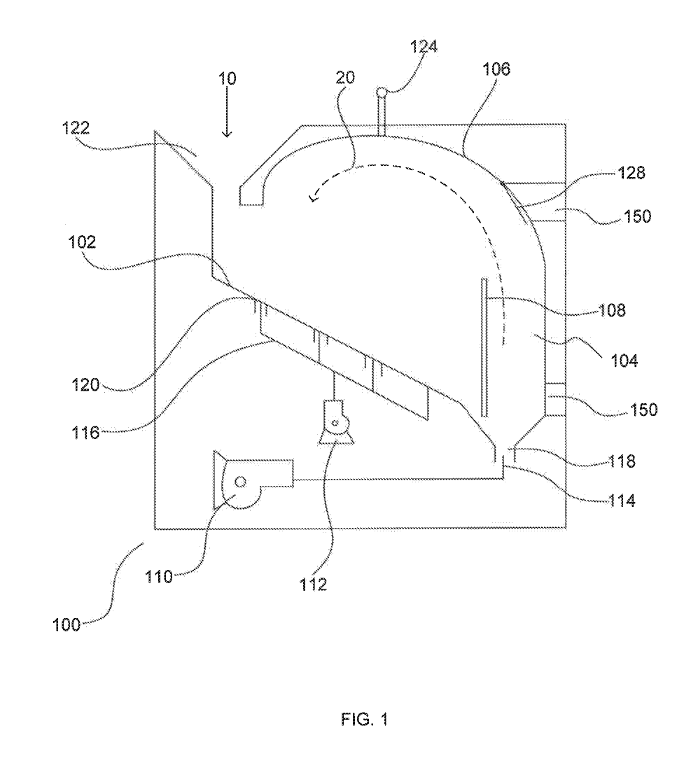

In accordance with an exemplary embodiment of the present invention, as illustrated in FIG. 1, a dryer system 100 may include a biomass product intake 122 for directing biomass product 10 into a vessel comprising a bed 102 having air ports 120 for fluidizing a biomass product 10. Bed 102 may be a downcomer sloped sufficiently to transport biomass product 10 when fluidized by air delivered from air ports 120. Air ports 120 include any nozzle, baffle, perforation or the like in downcomer 102 sufficient to delivery enough air through downcomer 102 to fluidize biomass product 10 and sufficiently transport biomass product 10 along the length of downcomer 102. Air may be plumbed to air ports 120 though air delivery system 116 in any manner sufficient to deliver a low velocity air in enough quantity to fluidize biomass product 10. Air supply 112 may provide air delivery system 116 with sufficient air to fluidize the biomass material, mixing it and transporting it down downcomer 102. Air supply 112 may be any air supply system including for example, air pumps, fans, compressors, billows etc. Downcomer 102 may direct biomass product 10 to a riser 104. In accordance with various embodiments, a baffle 108 may separate downcomer 102 from riser 104. Baffle 108 may also be configured to open and close, controlling the flow and amount of fluidized biomass product 10 into riser 104. In accordance with various embodiments, riser 104 may receive air supplied through an air port 118, through an air delivery system 116, from air supply 110. Air supply 110 may be configured to provide air delivery system 116 with a sufficient air supply to expel air from air port 118 at a sufficient velocity to propel biomass product 10 up riser 104. In one example biomass product 10 is propelled against a deflector 106 along the product path 20 depicted by the dotted line in FIG. 1. In accordance with one embodiment an exit port 150 may be located at the bottom and/or the top of riser 104. In one example, exit port 150 may be used to extract material from the chamber when the chamber functions as a batch system. In another example, exit port 150 may be used to direct biomass product 10 to a second chamber. Gate 128 may cover exit port 150 preventing biomass product 10 from exiting the system at an undesirable time. However, Gate 128 may be manually our automatically (e.g. via the micro controller) opened allowing biomass product 10 to exit the system. Gate 128 may also function as a deflector plate, directing biomass product 10 into exit port 150. Air supply 110 may be any air supply system including for example, air pumps, fans, compressors, billows etc. Drying system 100 may also have an exhaust port 124 for removing air from the system as the air collect moisture from biomass product 10. In various embodiments a condenser and/or a cyclone may be connected to the exhaust air to remove oils and particulate matter from the exhaust stream. In accordance with various embodiments of the present invention, while not shown in the illustration, the drying system may also include at least on of a biomass product temperature sensor, an air temperature sensor, biomass product weight sensor, and a relative air humidity sensor.

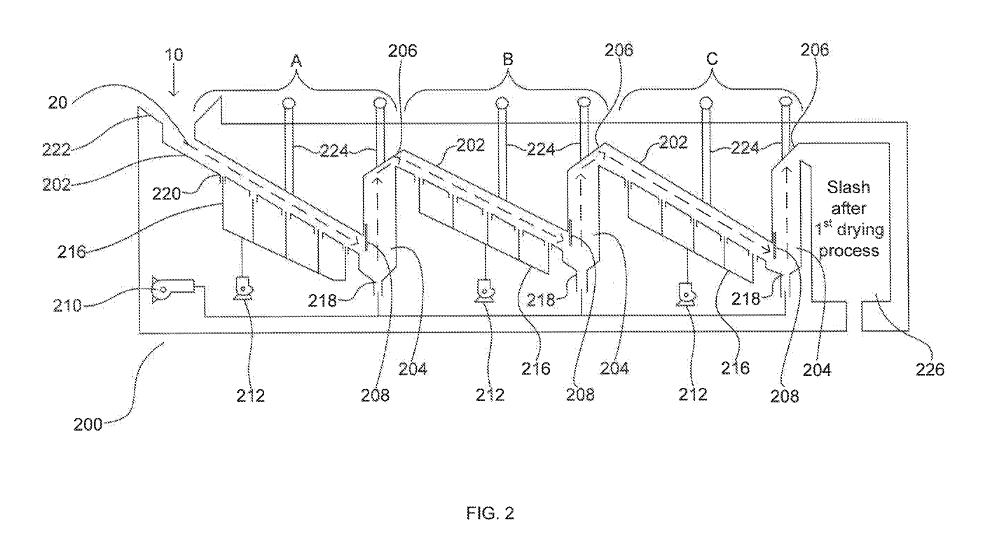

In accordance with an exemplary embodiment of the present invention, as illustrated in FIG. 2, a dryer system 200 may include a biomass product intake 222 for directing biomass product 10 into vessel comprising a series of downcomers 202 and risers 204 along biomass path 20 (shown as a dotted line) through multiple stages illustrated as A, B, and C. Air may be directed to the downcomers by delivery system 216 from air supply 212. Air may also be directed to the risers by delivery system 214 from air supply 210. Low velocity air delivered through air ports 220 may be sufficient to fluidize the biomass product and allow it flow down downcomer 202 to riser 208. High velocity air delivered through air port 218 may be sufficient to direct the fluidized material up riser 204, against a deflector 206, and into the next downcomer 202. Baffle 208 may separate downcomer 202 from riser 204. Baffle 208 may also be adjustable to control the flow of biomass product into riser 204. Air introduced into dryer system 200 may be exited through exhaust port 224 directly to the outside air or in accordance with other methods discussed herein. In accordance with one embodiment, biomass material will travel through the downcomer and riser in stage A, then stage B, then stage C and exit the system in holding vessel 226. In accordance with various embodiments, dryer system 200 may comprise one or more stages; stages A, B, and C are merely shown as an example. Furthermore, air supplied to each of the stages may be different in accordance with the moisture content of the biomass material as it reaches the stages. For example, the air supply may be hotter or cooler in each of the zones or delivered at a higher or lower relative velocity in each of the stages in order to optimize efficient drying of the biomass product.

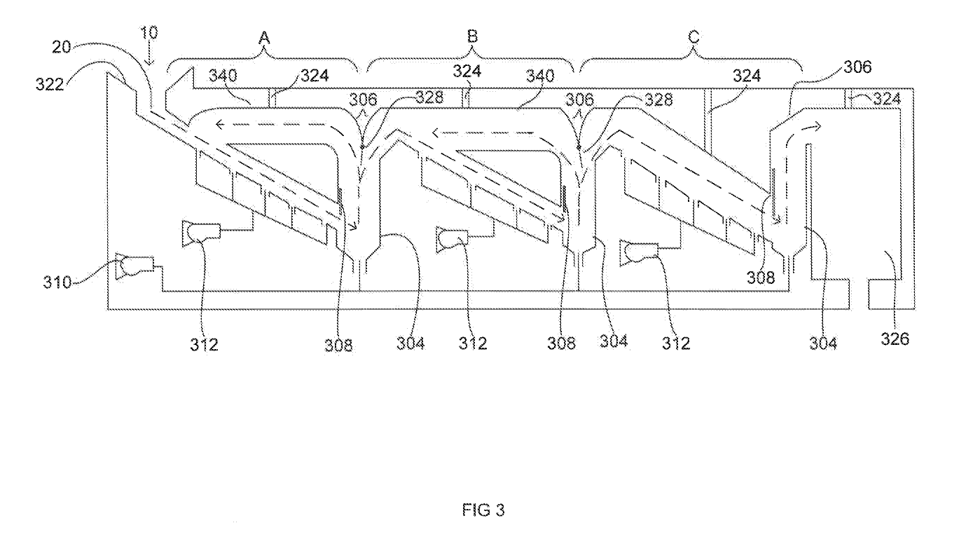

In accordance with an exemplary embodiment of the present invention, as illustrated in FIG. 3, a dryer system 300 may include a biomass product intake 322 for directing biomass product 10 to vessel comprising a series of downcomers 302 and risers 304 along biomass path 20 (shown as a dotted line) through multiple stages illustrated as A, B, and C. Air may be directed to the downcomers by delivery system 316 from air supply 312. Air may also be directed to the risers by delivery system 314 from air supply 310. Low velocity air delivered through air ports 320 may be sufficient to fluidize the biomass product and allow it flow down downcomer 302 to riser 308. High velocity air delivered through air port 318 may be sufficient to direct the fluidized material up riser 304, against a deflector 306, and into the next downcomer 302. Alternatively, high velocity air delivered through air port 318 may be sufficient to direct the fluidized material up riser 304, against a deflector 306, and into the recycling path 340 returning the material to the same downcomer. In accordance with various embodiment gate 328 may direct a portion of or all of the material either back through the same stage or into the next stage. For example gate 328 between stage A and B may direct the material back though stage A or into the downcomer of stage B. Baffle 308 may separate downcomer 302 from riser 304. Baffle 308 may also be adjustable to control the flow of biomass product into riser 304. Air introduced into dryer system 300 may be exited through exhaust port 324 directly to the outside air or in accordance with other methods discussed herein. In accordance with one embodiment, biomass material will travel through the downcomer and riser in stage A, then stage B, then stage C and exit the system in holding vessel 226. Biomass material may also recycle back though stage A and/or stage B before advancing. In accordance with various embodiments, dryer system 200 may comprise one or more stages; stages A, B, and C are merely shown as an example.

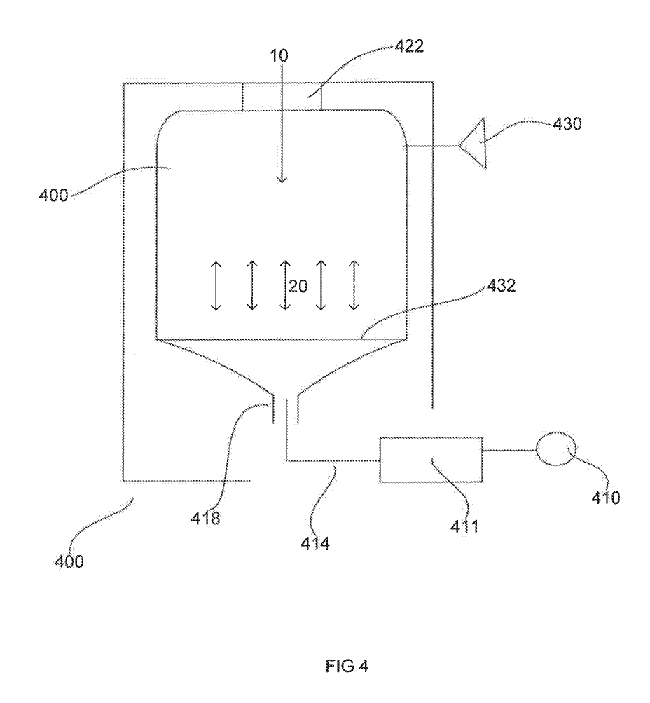

In accordance with an exemplary embodiment of the present invention, as illustrated in FIG. 4, a dryer system 400 may include a biomass product intake 422 for directing biomass product 10 into vessel 401. Vessel 401 may comprise a biomass support screen 432 and/or an air port 418. Air port 418 may receive air from delivery system 414 connected to a pulse generator 411. Pulse generator 411 may receive air from an air supply 410, in accordance with various embodiments, pulse generator 411 may cause the air supply to be periodic. The periodic or pulsated air supplied through air port 418 may cause the biomass material in vessel 401 to oscillate in such a manner as to fluidize the material, shown by vertical arrows 20. Port 430 may exit the air from vassal 401 and/or absorb the pressure changes in the vessel. Port 430 may also connect to a condenser and/or cyclone for oil and particulate matter recovery.

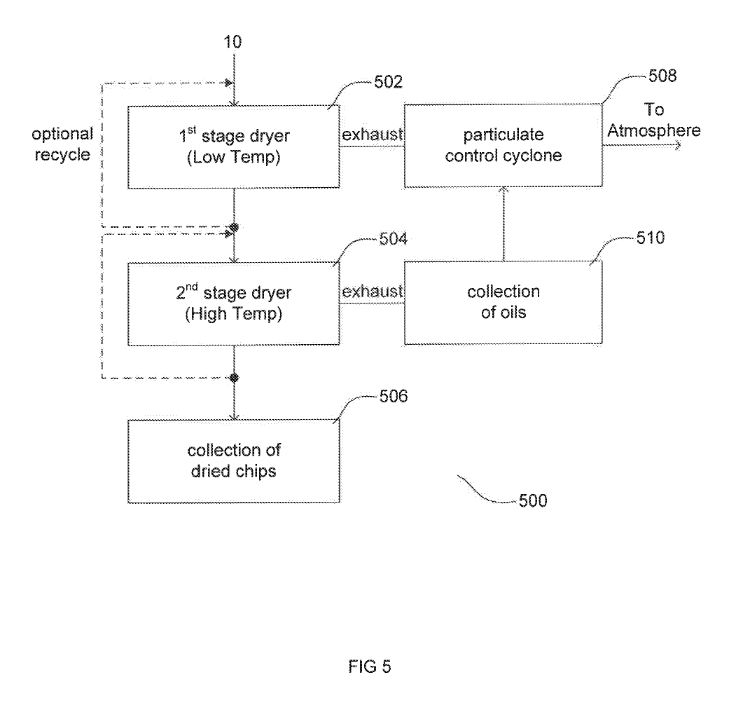

In accordance with exemplary embodiments of the present invention, as illustrated in FIG. 5, a dryer process 500 may include a first stage dryer 502, a second stage dryer 504. Biomass material may be introduced into the first stage dryer 502. Air may be used to dry the biomass material in the first stage dryer 502. First stage dryer 502 may be a low temperature air preventing the volatilization of internal oils of the biomass material. In response to completion of the first stage dryer 502, biomass material may advance to a second stage dryer or be recycled back into the first stage dryer. Second stage dryer 504 may be a high temperature air volatilizing the internal oils of the biomass material and reducing the moisture content down to a commercially usable content. In response to completion of the second stage dryer 504 the biomass material may be collected and/or recycled back to the beginning of the second stage. Exhaust gasses from the first stage 502 may be transported to a particulate control cyclone and then ejected into the atmosphere. Exhaust from the second stage 504 may be sent to a condenser to collect the oils and other products prior to advancing to the particulate control cyclone and ultimately being ejected into the atmosphere.

### EXAMPLE 1

In one example, a dryer system has a single batch chamber with a downcomer, a baffle, and a riser. The downcomer has a downward angle of about 45 degrees receiving a continuous flow of air. The air continuously dries and mixes a woody pine biomass product resident in the downcomer. The bed footprint is 12 inches by 6 inches. The riser is a narrow slot about 3 inches wide and the depth of the bed. The air provided to the system is less than 300 cfm and has a temperature that is between ambient and 140° F. The deflector in the system deflects the biomass product back to the downcomer.

Various principles of the present invention have been described in exemplary embodiments. However, many combinations and modifications of the above-described structures, arrangements, proportions, elements, materials, and components, used in the practice of the invention, in addition to those not specifically described, can he varied without departing from those principles. Various embodiments have been described as comprising automatic processes, but this process may be performed manually without departing from the scope of the present invention. Furthermore, the benefits, advantages, solutions to problems, and any elements that may cause any benefit, advantage, or solution to occur or become more pronounced are not to be construed as critical, required, or essential features or elements of the invention. The scope of the invention is accordingly to be limited by nothing other than the appended claims, in which reference to an element in the singular is not intended to mean “one and only one” unless explicitly so stated, but rather “one or more.” All structural and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus.

What is claimed is:

1. A method for drying a biomass product comprising:
introducing a biomass product with a first moisture content into a downcomer in a first chamber in a vessel;
injecting a fluidizing media at a first velocity through a bed of the downcomer fluidizing the biomass product;
directing the biomass product down the downcomer to a riser;
injecting the fluidizing media at a second velocity through a bottom nozzle in the riser fluidizing the biomass product;
directing the biomass product up the riser; and
fluidizing the biomass product until a second moisture content is obtained.

2. The method of claim 1, further comprising: directing said biomass product out of the riser and into a second chamber having a downcomer and riser.

3. The method of claim 1, further comprising: operating the chamber in a first stage and a second stage.

4. The method of claim 3, wherein the first stage comprises injecting the fluidizing media at ambient temperature or less and obtaining the second moisture content.

5. The method of claim 3, wherein the second stage comprises injecting the fluidizing media at greater than ambient temperature and obtaining a final moisture content.

6. The method of claim 1, further comprising: obtaining the second moisture content without substantially removing the volatile pine oils in the chips.

7. The method of claim 1, wherein the second moisture content is less than 35%.

8. The method of claim 1, wherein the second moisture content is less than 25%.

9. The method of claim 1, wherein the second moisture content is less than 20%.

10. The method of claim 1, wherein the second moisture content is less than 10%.

11. A system for drying a biomass product comprising:
a vessel;
a chamber contained within the vessel;
a fluidizing bed in the chamber; and
a supply of fluidizing media in communication with the fluidizing bed, wherein the fluidizing media is delivered as a cyclic pulse, wherein the fluidizing media is at a first temperature in a first stage.

12. The system of claim 11, wherein the first stage uses air at or below ambient temperature.

13. The system of claim 11, wherein the fluidizing media is also supplied at a second temperature in a second stage, wherein the second stage uses air above ambient temperature.

14. The system of claim 11, wherein the fluidized bed is screed situated in the chamber to support the biomass product and allow the cyclic pulse of fluidizing media to be delivered below the biomass product causing the biomass product to be fluidized in the fluidizing bed.

15. The system of claim 11, wherein the fluidized bed is a downcomer and the fluidization is obtained by introducing the fluidizing media through a constant low velocity air stream delivered up through the down comber causing the biomass product to be fluidized on the downcomer.

16. A fluidized bed for drying a biomass product comprising:
an inlet for receiving a biomass product;
a downcomer including a low velocity stream of fluidizing media corning up through a bed configured to fluidize the biomass product and direct the biomass product to a low point at the bottom of the downcomer;
a riser including a high velocity stream of fluidizing media injected at the bottom of the riser and configured to move the biomass product higher in the riser.

17. The fluidized bed of claim 16, further comprising: an adjustable baffle located between the downcomer and the riser.

18. The fluidized bed of claim 16, further comprising: a deflector configured to direct biomass product in the riser back to the downcomer.

19. The fluidized bed of claim 16, further comprising: a deflector configured to direct biomass product in the riser to a second downcomer in communication with the riser.

20. The fluidized bed of claim 16, wherein the fluidizing media is air recycled from the exhaust of another system.
